(19) United States
(12) Patent Application Publication
(10) Pub. No.: US 2026/0311665 A1
(43) Pub. Date: Oct. 8, 2026

(54) INFORMATION GENERATION METHOD, ELECTRONIC DEVICE AND STORAGE MEDIUM

(71) Applicant: Beijing Zitiao Network Technology Co., Ltd., Beijing (CN)

(72) Inventors: Xuebing ZHAO, Beijing (CN); Mingxian Yan, Beijing (CN); Ran Shu, Beijing (CN); Qian Mao, Beijing (CN)

(21) Appl. No.: 19/660,047

(22) Filed: Apr. 27, 2026

(30) Foreign Application Priority Data
Apr. 27, 2025 (CN) 202510541745.7

(51) Int. Cl. G10H 1/00; G06F 9/445

(52) U.S. Cl. CPC G10H 1/0008; G06F 9/44526; G10H 2220/131

(57) ABSTRACT

The present disclosure provides an information generation method, an electronic device, and a storage medium. The method includes: acquiring multimodal input data, wherein the multimodal input data includes at least two types of media data, and the multimodal input data is configured to represent a first intention based on the at least two types of media data; processing the multimodal input data through a music processing agent, and invoking at least one music processing plugin according to a processing result to obtain a respective one of media resources corresponding to each of the at least one music processing plugin; and combining the media resources, each of which corresponds to a respective one of the at least one music processing plugin, to generate visual music information matching the first intention.

### CROSS-REFERENCE TO RELATED APPLICATION

This application claims the priority to and benefits of the Chinese Patent Application, No. 202510541745.7, which was filed on Apr. 27, 2025. The aforementioned patent application is hereby incorporated by reference in its entirety.

### TECHNICAL FIELD

One or more embodiments of the present disclosure relate to the field of artificial intelligence technologies, and in particular, to an information generation method, an electronic device, and a storage medium.

### BACKGROUND

At present, with the rise and development of large models, content generation capabilities based on large models are being applied more and more widely, for example, article continuation, content summarization, image generation, etc. are carried out based on semantic understanding and reasoning capabilities of the large models.

In the prior art, a music processing function based on a large model is usually implemented by processing a description text input by a user through the large model. However, in the scheme of the prior art, it is difficult for the large model to accurately obtain the user intention, which leads to the problems of poor usability and low interaction efficiency in the music processing function implemented based on the large model.

### SUMMARY

One or more embodiments of the present disclosure provide an information generation method and apparatus, an electronic device, and a storage medium to overcome the problems of poor usability and low interaction efficiency in a music processing function.

At least an embodiment of the present disclosure provides an information generation method, including:

acquiring multimodal input data, wherein the multimodal input data comprises at least two types of media data, and the multimodal input data is configured to represent a target intention (e.g., first intention) based on the at least two types of media data; processing the multimodal input data through a music processing agent, and invoking at least one music processing plugin according to a processing result to obtain a respective one of media resources corresponding to each of the at least one music processing plugin; and combining the media resources, each of which corresponds to a respective one of the at least one music processing plugin, to generate visual music information matching the target intention.

At least an embodiment of the present disclosure further provides an information generation apparatus, including:

an acquiring module, configured to acquire multimodal input data, wherein the multimodal input data comprises at least two types of media data, and the multimodal input data is configured to represent a target intention based on the at least two types of media data;

a processing module, configured to process the multimodal input data through a music processing agent, and invoking at least one music processing plugin according to a processing result to obtain a respective one of media resources corresponding to each of the at least one music processing plugin; and

a generating module, configured to combine the media resources, each of which corresponds to a respective one of the at least one music processing plugin, to generate visual music information matching the target intention.

### At least an embodiment of the present disclosure further provides an electronic device, including:

at least one processor; and

a memory communicatively connected to the at least one processor,

wherein the memory is stored with a computer instruction executable by the processor, and the computer instruction, when executed by the processor, causes the processor to perform the information generation method according to the above embodiments.

At least an embodiment of the present disclosure provides a non-transitory computer-readable storage medium, where the computer-readable storage medium is stored with computer instructions, and the computer instructions, when executed by at least a processor, cause the processor to implement the information generation method according to the above embodiments.

At least an embodiment of the present disclosure provides a computer program product, including a computer program, and wherein the computer program, when executed by a processor, causes the processor to perform the information generation method according to the above embodiments.

### BRIEF DESCRIPTION OF DRAWINGS

In order to more clearly illustrate the technical solutions in one or more embodiments of the present disclosure or in the prior art, the following will briefly introduce the drawings that need to be used in the description of the embodiments or the prior art. Obviously, the drawings in the following description are some embodiments of the present disclosure. For those of ordinary skill in the art, other drawings may be obtained based on these drawings without paying creative efforts.

FIG. 1 is an application scenario diagram of an information generation method provided by at least an embodiment of the present disclosure;

FIG. 2 is a first schematic flowchart of an information generation method provided by at least an embodiment of the present disclosure;

FIG. 3 is a schematic diagram of a process of generating visual music information provided by at least an embodiment of the present disclosure;

FIG. 4 is a flowchart of a specific implementation of step S103 in at least embodiment shown in FIG. 2;

FIG. 5 is a flowchart of a specific implementation of step S1031 in at least embodiment shown in FIG. 4;

FIG. 6 is a second schematic flowchart of an information generation method provided by at least an embodiment of the present disclosure;

FIG. 7 is a flowchart of a specific implementation of step S203 in at least embodiment shown in FIG. 6;

FIG. 8 is a flowchart of a specific implementation of step S204A in at least embodiment shown in FIG. 6;

FIG. 9 is a schematic diagram of an invoking process of a music processing plugin provided by at least an embodiment of the present disclosure;

FIG. 10 is a schematic diagram of a process of generating visual music information provided by at least an embodiment of the present disclosure;

FIG. 11 is a structural block diagram of an information generation apparatus provided by at least an embodiment of the present disclosure;

FIG. 12 is a schematic structural diagram of an electronic device provided by at least an embodiment of the present disclosure; and

FIG. 13 is a schematic hardware structural diagram of an electronic device provided by at least an embodiment of the present disclosure.

### DETAILED DESCRIPTION

In order to make the purpose, technical solutions and advantages of one or more embodiments of the present disclosure clearer, the technical solutions in one or more embodiments of the present disclosure will be clearly and completely described below in conjunction with the drawings in one or more embodiments of the present disclosure. Obviously, the described embodiments are part of one or more embodiments of the present disclosure, not all of them. Based on the embodiments in the present disclosure, all other embodiments obtained by persons of ordinary skill in the art without creative efforts fall within the protection scope of the present disclosure.

It should be noted that the user information (including but not limited to user device information, user personal information, etc.) and data (including but not limited to data for analysis, stored data, displayed data, etc.) involved in the present disclosure are all information and data authorized by the user or fully authorized by all parties, and the collection, use and processing of relevant data need to comply with relevant laws, regulations and standards of relevant countries and regions, and provide corresponding operation entry for users to choose authorization or rejection.

### The application scenarios of one or more embodiments of the present disclosure are explained below:

The information generation method provided by one or more embodiments of the present disclosure may be applied to applications (APPs) with music search and playback functions, such as music applications, intelligent AI assistant programs, and browser programs, etc. More specifically, it may be applied to application scenarios such as music search and intelligent music matching based on AI assistants. The execution body of this embodiment may be a terminal device running the above-mentioned application with music search and playback functions, or a server deploying the server corresponding to the above-mentioned application, or other electronic devices that perform similar functions. When the execution body is a terminal device, the terminal device executes the method provided in this embodiment by running the above-mentioned application; when the execution body is a server, the server of the above-mentioned application with music search and playback functions may run partially or completely on the server, and the method provided in this embodiment is executed on the server side, while the terminal device runs the client of the application, and the server and the terminal device communicate based on the server-client, so that the terminal device may obtain the execution result of the method provided in this embodiment and display it as needed.

In some embodiments, the terminal device or the server may implement the information generation method provided by one or more embodiments of the present disclosure by running various computer-executable instructions or computer programs. For example, the computer-executable instructions may be program-level commands, machine instructions or software instructions. The computer program may be a native program or a software module in an operating system; it may be a local application, that is, a program that needs to be installed in the operating system to run, or it may be a mini-program embedded in any APP, that is, a program that runs based on a browser environment. In summary, the above computer-executable instructions may be any form of instructions, and the above computer programs may be any form of applications, modules or plugins, and the specific implementation form may be configured as needed. Further, in the process of implementing the information generation method provided by one or more embodiments of the present disclosure, the terminal device may execute the method by running computer-executable instructions or computer programs set locally, or may execute the method by invoking computer-executable instructions or computer programs set in an external server. In some embodiments, the server may be an independent physical server, a server cluster or a distributed system composed of multiple physical servers, or may provide cloud services, cloud storage, cloud communication, cloud databases, cloud computing, cloud functions, network services, middleware services, domain name services, security services, content delivery networks (Content Delivery Network, CDN), and cloud servers for basic cloud computing services such as big data and artificial intelligence platforms, where the cloud services may be interactive processing services for the terminal device to call.

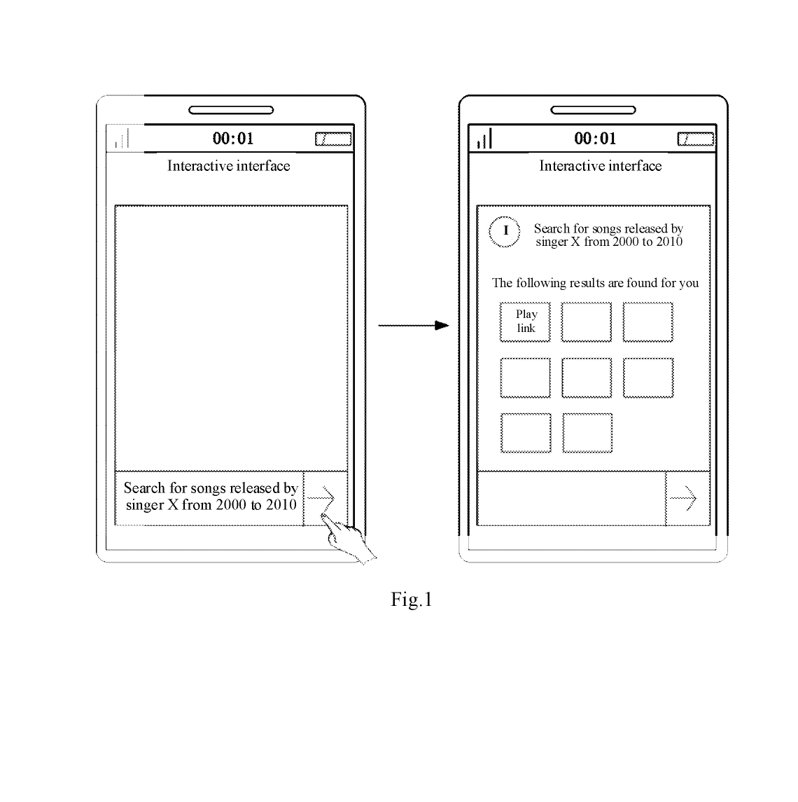

FIG. 1 is an application scenario diagram of an information generation method provided by at least an embodiment of the present disclosure. As shown in FIG. 1, taking a terminal device as an example, a target application with a music search function is run in the terminal device, and a user inputs a demand text through an interactive interface of the target application, such as "search for songs released by singer X from 2000 to 2010". After that, the target application performs semantic understanding through a large model and then performs Internet search, searches for a matching query result from the Internet or a data server of the target application, and displays contents such as a song name and a song playing link in the target application, thereby completing a response to the user demand (song query). For example, as shown in the figure, the text of "the following results are found for you" and the corresponding song playing link are displayed in the interactive interface.

In the prior art, in a use scenario of the music processing function as shown in FIG. 1, when the user demand is relatively clear and simple, after using the large model to perform semantic understanding on the demand text, the corresponding functional processing steps may be performed more accurately, thereby obtaining a processing result that satisfies the user demand. However, for some complex application scenarios and requirements, such as intelligent music matching for voice or image, music search based on emotional features, music recognition, etc. It is difficult to accurately and clearly describe the user intention only through the demand text, and the large model usually uses the text as input to perform recognition and reasoning, which makes it difficult for the large model to accurately recognize the user intention and then execute processing instructions with deviations or even errors, which discounts the execution effect of the music processing function and reduces its usability. At the same time, only describing the user demand through the demand text increases the difficulty in designing the demand text, which will lead to the user repeatedly modifying and debugging the description text, resulting in problems such as low interaction efficiency.

One or more embodiments of the present disclosure provides an information generation method to solve the above problems.

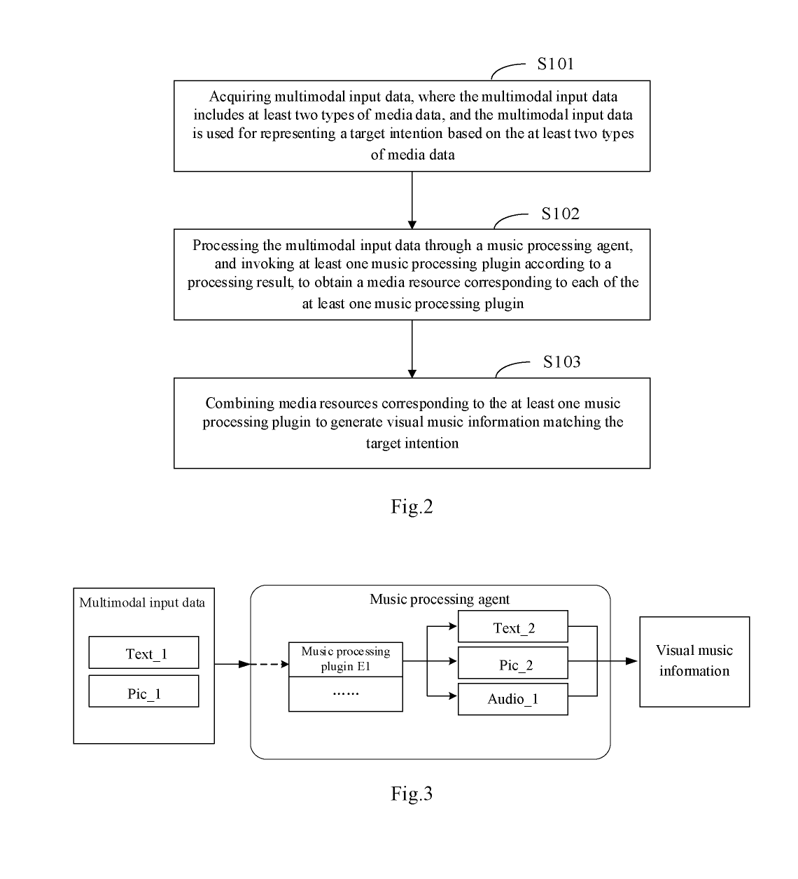

Referring to FIG. 2, FIG. 2 is a first schematic flowchart of an information generation method provided by at least an embodiment of the present disclosure. The method of this embodiment may be applied to a terminal device or a server. For the case where the terminal device executes the method provided by this embodiment, in a possible implementation, the terminal device may implement the information generation method provided by this embodiment by executing program codes deployed locally. In another possible implementation, a server may be used to deploy a functional service implemented based on the information generation method provided by this embodiment, and the terminal device may implement the information generation method provided by this embodiment by accessing the above-mentioned server and invoking the corresponding functional service. Exemplarily, the information generation method provided by this embodiment includes:

Step S101: acquiring multimodal input data, where the multimodal input data includes at least two types of media data, and the multimodal input data is configured to represent a target intention based on the at least two types of media data.

Step S102: processing the multimodal input data through a music processing agent, and invoking at least one music processing plugin according to a processing result to obtain a media resource corresponding to each of the at least one music processing plugin.

Step S103: combining media resources corresponding to the at least one music processing plugin to generate visual music information matching the target intention.

Referring to the schematic diagram of the application scenario shown in FIG. 1, in this embodiment, the provided information generation method is introduced by taking the terminal device as an execution body. Exemplarily, the terminal device runs a target application and provides an interactive interface to a user through the target application, and the user causes the terminal device to load multimodal input data by selecting locally or from the cloud, voice input or keyboard input, etc. from the interactive interface, where the multimodal input data is composed of at least two types of media data, and the multimodal input data is configured to represent a target intention based on the at least two types of media data. Specifically, for example, the media data includes text, image, audio and video. In an example, the multimodal input data is composed of text and pictures, which may be expressed as RData_1=[text_1, pic_1, pic_2]. Wherein, RData_1 is the multimodal input data, text_1 is a piece of text, and pic_1 and pic_2 are two different pictures respectively. In another example, the multimodal input data is composed of pictures, audio and video, which may be expressed as RData_2=[pic_1, audio_1, video_1]. Wherein, RData_2 is the multimodal input data, pic_1 is a picture, audio_1 is a piece of audio, and video_1 is a piece of video. The target intention is represented by the above at least two types of media data, for example, the multimodal input data is composed of text data and video data, and the content of the text data is "match music for the following video", thus, through the text data and the video data, the target intention of the user is accurately described, and the problem that it is difficult to clearly express the user demand only through the text data (demand text) is solved.

Further, the above multimodal input data may be acquired by the terminal device in response to corresponding operations of the user, for example, the text data is acquired by responding to words input by the user in a text box in the interactive interface, and the video data is acquired by loading a local video in response to a click instruction of the user in the interactive interface, etc. The specific implementation of the terminal device to acquire the multimodal input data may be set as needed, which will not be repeated here.

Further, after acquiring the multimodal input data, the terminal device invokes a preset music processing agent to process it, where the music processing agent is a program with a music processing function for executing music-related tasks, which is implemented based on a large model, and the language understanding, reasoning and generation capabilities provided by the large model are configured to help the music processing agent complete final decision-making and action execution. The music processing agent invokes a corresponding music processing plugin to implement a specific skill action, that is, the music processing plugin is a program configured to implement specific skills, functions, etc., and is connected to the music processing agent in a pluggable manner, that is, the music processing agent may load the music processing plugin to use the functions provided by the music processing plugin, and after use, unload the music processing plugin to reduce the occupancy of interfaces and resources. Specifically, for example, when the music processing agent needs to perform a skill action A (for example, intelligent music matching), it invokes a music processing plugin ex_A that has the ability to perform the skill action A to perform it. Correspondingly, after the music processing plugin performs the corresponding action, it outputs a corresponding processing result, that is, the media resource corresponding to the music processing plugin, and the media resource may be one or more of text, picture, audio and video.

After the multimodal input data is processed by the music processing agent, based on the target intention, the music processing agent may invoke one or more music processing plugins to perform corresponding actions, and accordingly obtain one or more corresponding media resources. After that, it is necessary to combine the one or more corresponding media resources to obtain a processing result that matches the target intention of the user for display, that is, the visual music information.

FIG. 3 is a schematic diagram of a process of generating visual music information provided by at least an embodiment of the present disclosure. The above process will be further introduced below in conjunction with FIG. 3. As shown in FIG. 3, exemplarily, based on the multimodal input data being composed of text Text_1 and picture Pic_1, the represented target intention may be expressed as "match music for an image", and after the above step of invoking the corresponding music processing plugin E1 through the music processing agent for processing, three types of media resources are obtained, which are a piece of text Text_2, a picture Pic_2 and a piece of audio Audio_1 respectively, and the above three types of media resources are combined according to a certain layout to form the visual music information, which is displayed on the terminal device. More specifically, the text Text_2 is, for example, an introduction to the content of the picture, and/or the characteristics of the audio and the name of the audio; the picture Pic_2 is, for example, a music album cover similar to the picture Pic_1; and the audio Audio_1 is the music matching result for the picture Pic_1.

Further, in a possible implementation, as shown in FIG. 4, the specific implementation of step S103 includes:

Step S1031: acquiring a visual template matching the target intention, where the visual template is configured to determine a layout style of the visual music information.

Step S1032: combining the media resources generated by the at least one music processing plugin based on the visual template to generate the visual music information matching the target intention.

Exemplarily, referring to FIG. 3, in the process of generating and displaying the visual music information in the interactive interface of the target application, a possible implementation is to generate the visual music information based on a fixed style template, such as a text resource being fixed at a first display position in the interactive interface, a video resource being fixed at a second display position in the interactive interface, etc., to implement the presentation of the processing result. In another possible implementation, as in the steps of this embodiment, the visual template matching the target intention is acquired, that is, the visual template is dynamically acquired, and then the media resources are arranged according to the layout style indicated by the visual template. Therefore, when the target intentions are different, different visual templates will be obtained, thereby causing the visual music information to present different layout styles. For example, in the case of a first-type intention (such as intelligent music matching), the generated audio resource is arranged at the first display position in the interactive interface; in the case of a second-type intention (such as music recognition), the generated audio resource is arranged at the second display position in the interactive interface. Through the steps of this embodiment, the visual music information may be presented in a layout style that matches the user intention, thereby improving the information display efficiency and display effect.

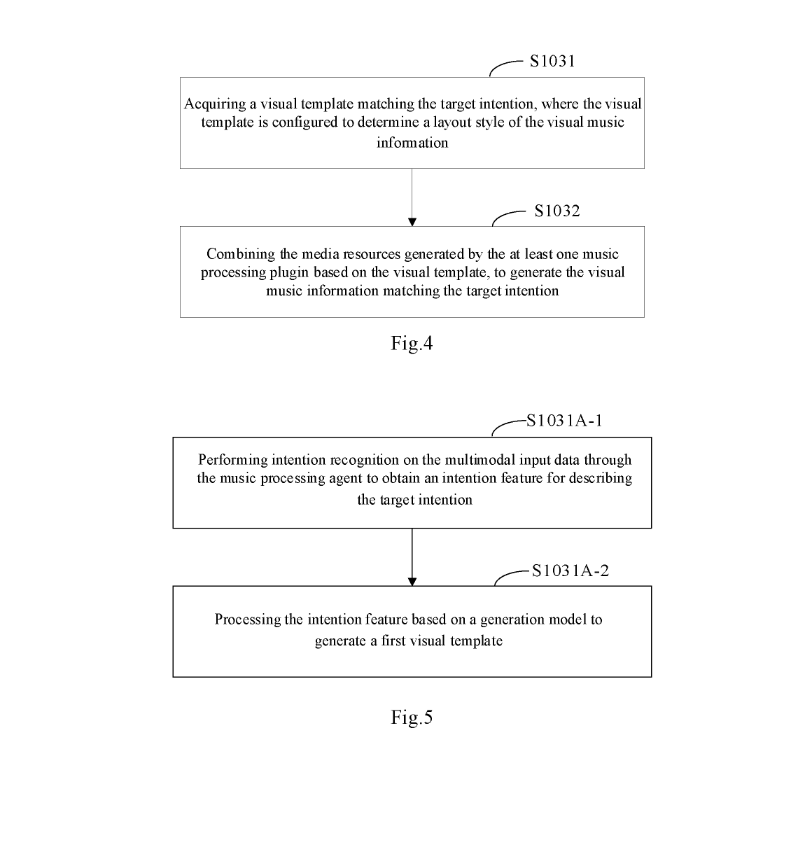

Further, in a possible implementation, the visual template includes a first visual template, and the first visual template is configured to represent a display position of a target media resource corresponding to the target intention. Correspondingly, as shown in FIG. 5, the specific implementation of step S1031 includes:

Step S1031A-1: performing intention recognition on the multimodal input data through a music processing agent to obtain an intention feature for describing the target intention.

Step S1031A-2: processing the intention feature based on a generation model to generate the first visual template.

Exemplarily, in the steps of this embodiment, firstly, intention recognition is performed on the multimodal input data through the music processing agent to obtain the intention feature. Specifically, the intention feature may be an intention feature vector or an intention feature matrix composed of feature values, and the target intention is described by the intention feature vector or the intention feature matrix. The greater the number of feature values, the more complex and precise the target intention that may be expressed, thereby realizing the precise expression of the target intention. After that, the intention feature is input into a pre-trained generation model, and the capability of the generation model is used to generate a visual template matching the intention feature, that is, the first visual template, where the first visual template is configured to represent a display position of at least one piece of media resource, and the first visual template restricts a first display position corresponding to a text resource, more specifically, for example, a prominent display position in the center of the interactive interface, thereby satisfying a specific target intention. The positions of the media resources not restricted by the first visual template may be determined based on a basic template, or the first visual template restricts the positions of the target media resources corresponding to all target intentions.

In the steps of this embodiment, the intention feature describing the target intention is obtained by performing intention recognition on the multimodal input data, and then the first visual template is generated based on the intention feature, so that the first visual template is a layout design only for the target media resource corresponding to the target intention. Therefore, the number of media resource bits in the first visual template is determined based on the target intention, rather than a fixed number. That is, there is no need to reserve media resource bits that are not involved in the target intention, so that the layout style represented by the first visual template may be more matched with the intention feature, thereby improving the rationality of the layout and the information display efficiency of the visual music information.

In another possible implementation, the visual template includes a second visual template, and the second visual template is configured to represent a user interface layout composed of a target number of media resource bits. Correspondingly, the specific implementation of step S1031 includes:

Step S1031B-1: performing intention recognition on the multimodal input data through a music processing agent to obtain a target intention category corresponding to the target intention and the number of media resource bits.

Step S1031B-2: acquiring the corresponding second visual template according to the target intention category and the number of media resource bits, where the second visual template is configured to represent a user interface layout composed of the target number of the media resource bits.

Exemplarily, in this embodiment, intention recognition is performed on the multimodal input data through the music processing agent to obtain the target intention category corresponding to the target intention, where the target intention category is one of preset intention categories and may be represented by a category identification. More specifically, the target intention category includes at least one of the following: intelligent music matching, music search, music identification, and music introduction. After that, the corresponding visual template is retrieved from a pre-generated visual template library according to the target intention category, and the second visual template may be obtained. The second visual template is configured to represent a user interface layout composed of a target number of media resource bits.

Further, in a possible implementation, the number of media resource bits is a fixed value corresponding to the target intention category, for example, when the target intention category is intelligent music matching, the corresponding target number is 3; when the target intention category is music search, the corresponding target number is 2, etc. The above mapping relationship may be set as needed and is not limited. In another possible implementation, the number of media resource bits is a value independent of the target intention category, which is obtained after the music processing agent performs intention recognition on the multimodal input data, and specifically is implemented by the capability provided by the pre-trained music processing agent, and the principle will not be repeated.

In the steps of this embodiment, intention recognition is performed on the multimodal input data through the music processing agent to obtain the target intention category and the number of media resource bits, and then the second visual template representing the user interface layout is determined based on the target intention category and the number of media resource bits, thereby improving the rationality of the layout of the second visual template. At the same time, the second visual template is pre-generated, which has a fast matching speed and a small overhead of computing resources, and improves the generation speed of the visual music information.

According to the information generation method provided by this embodiment, the multimodal input data is acquired, where the multimodal input data includes at least two types of media data, and the multimodal input data is configured to represent a target intention based on the at least two types of media data; the multimodal input data is processed through a music processing agent, and at least one music processing plugin is invoked according to a processing result to obtain a media resource corresponding to each of the at least one music processing plugin; and the media resources corresponding to the at least one music processing plugin are combined to generate visual music information matching the target intention. The multimodal input data composed of at least two types of media data is acquired through the music processing agent for reasoning, so as to better understand the target intention of the user, and then the music processing plugin is invoked to obtain the corresponding media resource, and after the media resources are combined, the visual music information matching the target intention is generated, so that the large model has a more accurate understanding of the user intention, and then uses a more matching music processing plugin to complete the music processing function, so that the finally generated visual music information is more accurate and better meets the user needs, and at the same time, due to the improved accuracy of the user intention, there is no need to supplement and modify the input of the large model multiple times, thereby improving the interaction efficiency in the implementation process of the music processing function.

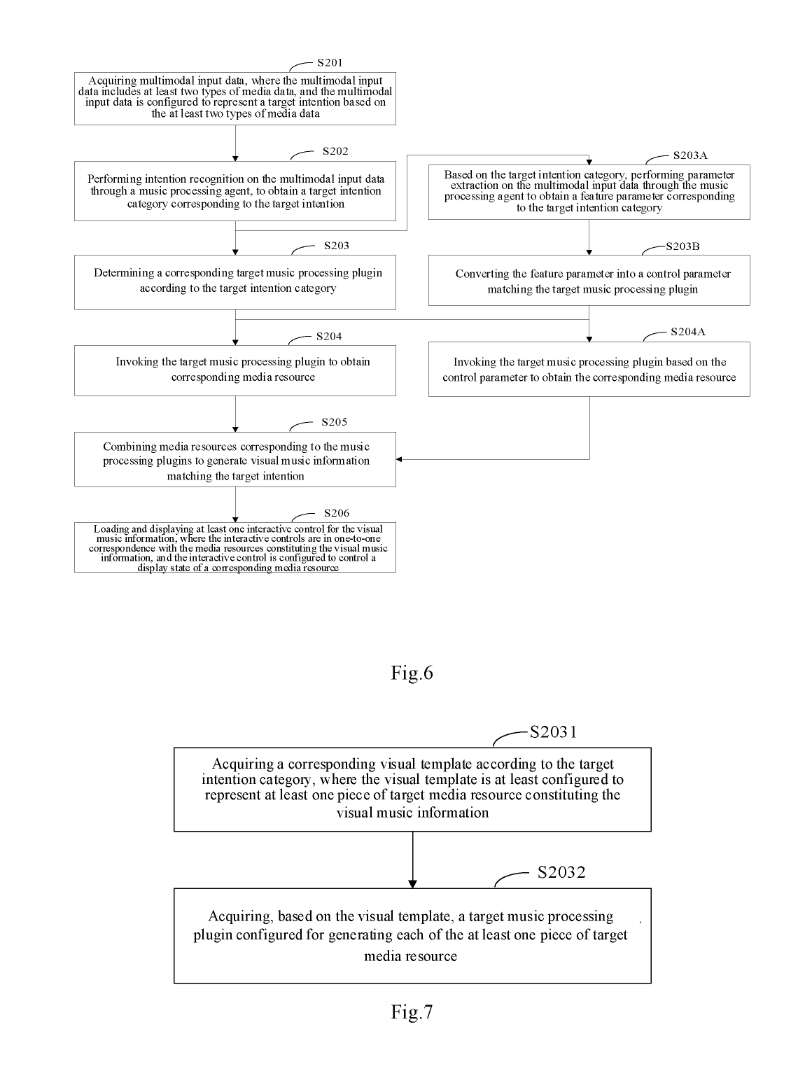

Referring to FIG. 6, FIG. 6 is a second schematic flowchart of an information generation method provided by at least an embodiment of the present disclosure. In this embodiment, step S102 is further specified on the basis of the embodiment shown in FIG. 2. The information generation method includes:

Step S201: acquiring multimodal input data, where the multimodal input data includes at least two types of media data, and the multimodal input data is configured to represent a target intention based on the at least two types of media data.

Step S202: performing intention recognition on the multimodal input data through a music processing agent to obtain a target intention category corresponding to the target intention.

Step S203: determining a corresponding target music processing plugin according to the target intention category.

Exemplarily, in combination with the introduction in the embodiment shown in FIG. 2, after the multimodal input data is acquired, intention recognition is performed on the multimodal input data by invoking the music processing agent to obtain the target intention category corresponding to the multimodal input data. Specifically, for example, firstly, feature extraction is performed on the multimodal input data by the music processing agent to obtain an intention feature matrix or an intention feature vector representing the target intention; after that, the intention feature matrix or the intention feature vector is classified and categorized into a certain preset category, thereby determining the target intention category. Exemplarily, the preset categories include: intelligent music matching, music search, music identification, music introduction, etc. The above target intention category corresponds to a function category or a skill category, and then, based on the above target intention category, a corresponding music processing plugin, that is, the target music processing plugin, that may implement the corresponding function or skill is selected. The intention category and the music processing plugin have a pre-configured mapping relationship, or the music processing agent has the capability of loading and using the music processing plugin corresponding to the preset intention category, thereby implementing the step of determining the corresponding target music processing plugin according to the target intention category.

Exemplarily, in another possible implementation, the music processing plugin is implemented based on workflow invocation, specifically, based on the above target intention category, a corresponding workflow, that is, a target workflow, that may implement the target intention category is selected, and then, in the process of executing the target workflow, when a more specific function or skill needs to be implemented, a corresponding music processing plugin, that is, the target music processing plugin, is invoked. The intention category and the workflow have a pre-configured mapping relationship, and the specific implementation of the workflow is prior knowledge. Alternatively, the music processing agent has the capability of loading and using the workflow corresponding to the preset intention category, thereby implementing the step of determining the corresponding workflow according to the target intention category, and then implementing the step of determining and invoking the target music processing plugin.

In a possible implementation, as shown in FIG. 7, the specific implementation of step S203 includes:

Step S2031: acquiring a corresponding visual template according to the target intention category, where the visual template is at least configured to represent at least one piece of target media resource constituting the visual music information.

Step S2032: acquiring, based on the visual template, a target music processing plugin configured to generat each of the at least one piece of target media resource.

In another possible implementation, after the target intention category is determined, a corresponding visual template may be first determined based on the target intention category, that is, different intention categories correspond to different visual templates, so that the visual music information is presented with different target media resources and different layout styles between the target media resources. After that, a corresponding workflow is triggered according to the target media resource (such as a text resource and a video resource) corresponding to the visual template, and then the music processing plugin in the workflow is invoked, that is, the plugin (target music processing plugin) that generates the result is derived in reverse from the result (media resource). After that, based on this, the control parameter input into the target music processing plugin is configured to represent and control the target intention, so that the media resource output by the target music processing plugin may satisfy the target intention.

In the steps of this embodiment, the target music processing plugin is determined in reverse based on the target media resource in the visual template after the visual template is first determined. Since the visual template is directly determined based on the target intention category, the accuracy of the generated visual music information and the degree of matching with the target intention may be improved.

Step S204: invoking the target music processing plugin to obtain a corresponding media resource.

Exemplarily, after the target music processing plugin is determined, the music processing agent invokes the target music processing plugin to use the capability of the target music processing plugin, thereby generating the media resource matching the target intention.

In another possible implementation, after step S202, it further includes:

Step S203A: based on the target intention category, performing parameter extraction on the multimodal input data through the music processing agent to obtain a feature parameter corresponding to the target intention category.

Step S203B: converting the feature parameter into a control parameter matching the target music processing plugin.

Exemplarily, in another implementation, after the target intention category is determined, parameter extraction is performed on the multimodal input data through the music processing agent to obtain the feature parameter corresponding to the target intention category, where the target intention category corresponds to a function category or a skill category, therefore, the feature parameter corresponding to the target intention category is an input parameter when performing a function or a skill equivalent to the target intention category. For example, if the target intention category is intelligent music matching, the feature parameter may be a parameter that represents information such as an image style and picture content obtained after the music processing agent performs parameter extraction on image data in the multimodal input data. After that, based on the obtained interface rule of the target music processing plugin, the feature parameter is converted into the control parameter matching the target music processing plugin, so as to input into the target music processing plugin in a subsequent step.

Correspondingly, the specific implementation of step S204 includes:

Step S204A: invoking the target music processing plugin based on the control parameter to obtain the corresponding media resource.

In this embodiment, parameter extraction is performed on the multimodal input data to obtain the feature parameter corresponding to the target intention category, and then the feature parameter is converted into the control parameter and input into the target music processing plugin, and the processing process of the target music processing plugin is constrained by the control parameter, so that the media resource output by the target music processing plugin is more accurate.

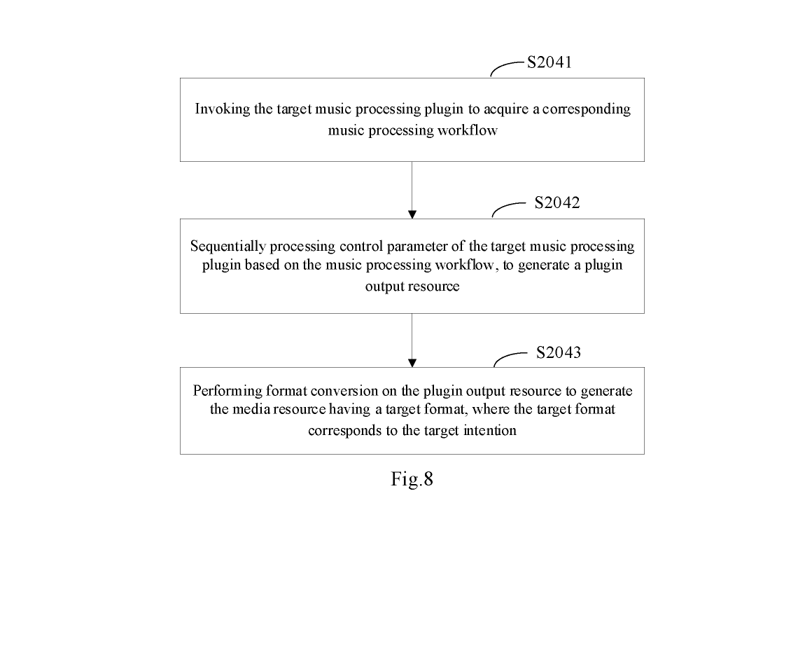

Further, in a possible implementation, as shown in FIG. 8, the specific implementation of step S204A includes:

Step S2041: invoking the target music processing plugin to acquire a corresponding music processing workflow.

Step S2042: sequentially processing the control parameter of the target music processing plugin based on the music processing workflow to generate a plugin output resource.

Step S2043: performing format conversion on the plugin output resource to generate a media resource having a target format, where the target format corresponds to the target intention.

Exemplarily, the above steps introduce the specific working principle of the target music processing plugin. Firstly, by invoking the target music processing plugin, a corresponding program is executed, thereby obtaining a processing flow recorded in the program, that is, the music processing workflow, and the music processing workflow may be composed of multiple working nodes. After that, the control parameter is sequentially processed based on each working node of the music processing workflow. Exemplarily, the control parameter may be input at a first working node of the music processing workflow, or may be input at a non-first working node. After that, the music processing workflow performs processing in a result iteration manner (that is, the output of the previous working node is used as the input of the next working node) until the last working node is executed, and then the plugin output resource is output. Finally, format conversion is performed on the plugin output resource based on a preset display format, or a text format and an image format corresponding to the target intention type, or a format requirement of the visual template, to generate the media resource having the target format. The purpose of the format conversion step is to unify the format of plugin output resources output by different music processing workflows, so as to facilitate the combination of the media resources in the subsequent step. The specific format conversion method may be configured as needed and is not limited here.

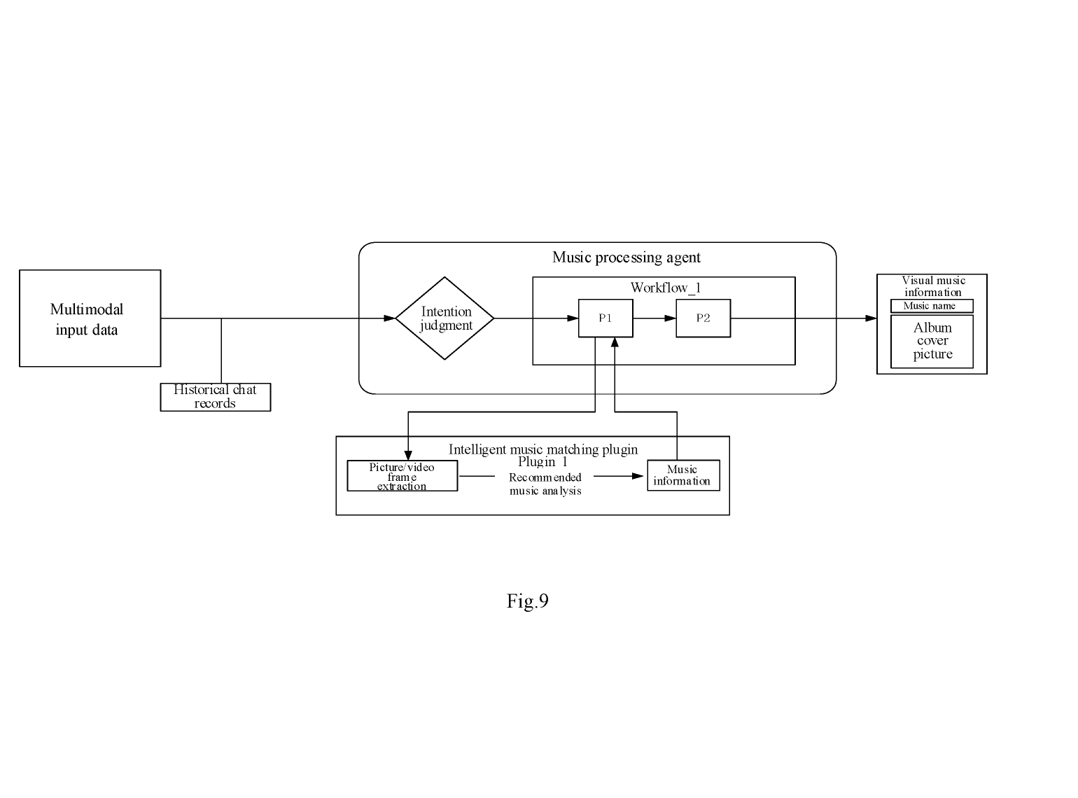

FIG. 9 is a schematic diagram of an invoking process of a music processing plugin provided by at least an embodiment of the present disclosure. The above process will be further introduced below in conjunction with FIG. 9. As shown in FIG. 9, firstly, a user inputs multimodal input data through an interactive interface, and then sends historical chat records and the above multimodal input data to a music processing agent for processing. The music processing agent performs intention judgment according to the multimodal input data and obtains that the corresponding target intention category is "intelligent music matching", and then determines the corresponding workflow Workflow_1. The workflow Workflow_1 includes a working node P1 that invokes an intelligent music matching plugin Plugin_1, where the intelligent music matching plugin Plugin_1 is deployed on a server, and the working node P1 corresponding to the intelligent music matching plugin Plugin_1 performs recommended music analysis according to a control parameter (picture or video frame extraction) input into the intelligent music matching plugin after being triggered, to obtain music information (for example, including a music name and an album cover picture) matching the above control parameter. After that, it is returned to the music processing agent, and the music processing agent continues to execute the next working node P2 in the workflow Workflow_1, and the working node is configured to performing format conversion on the music information, and combining contents such as the music name and the album cover picture in the music information based on a visual template to form visual music information, which is displayed in the interactive interface in the form of "text + card", where the text is the music name, and the card is configured to carry the album cover picture.

Step S205: combining the media resources corresponding to the at least one music processing plugin to generate the visual music information matching the target intention.

After obtaining the media resources corresponding to each music processing plugins based on the above steps, the media resources may be further combined in combination with the visual template, so as to form the visual music information having a layout style matching the target intention. For the specific implementation and technical effect, refer to the relevant introduction in the embodiment shown in FIG. 2, which will not be repeated here.

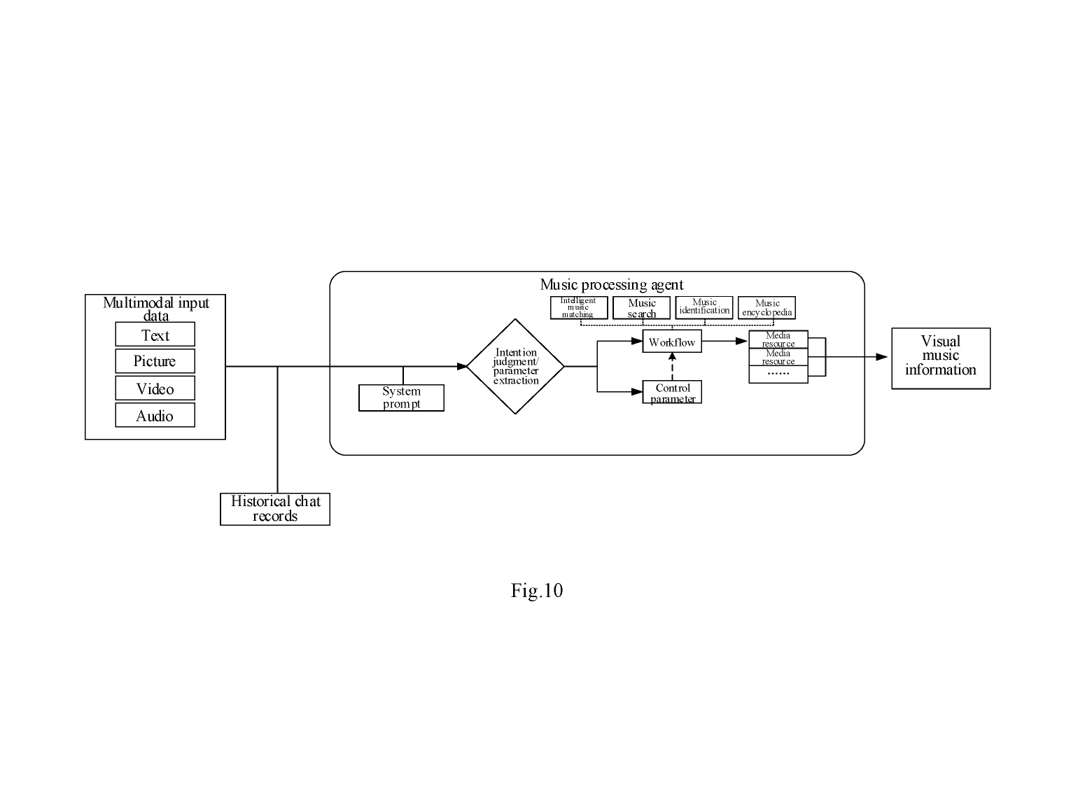

Further, FIG. 10 is a schematic diagram of a process of generating visual music information provided by at least an embodiment of the present disclosure. The steps of the above embodiment will be introduced in more detail below in conjunction with FIG. 10. As shown in FIG. 10, firstly, a user inputs multimodal input data containing various media data such as text, pictures, videos and audios through an interactive interface, and then sends historical chat records and the above multimodal input data to a music processing agent. After obtaining the historical chat records and the multimodal input data, the music processing agent first performs intention recognition and parameter extraction on the above historical chat records and multimodal input data based on a system prompt to obtain a workflow corresponding to the target intention category and a corresponding control parameter. After that, the corresponding workflow is executed based on the control parameter to implement the corresponding music processing task, such as the intelligent music matching task, the music search task, the music identification task, the music encyclopedia task, etc. shown in the figure, and the corresponding target music processing plugin is invoked in the execution process, so that the media resource output by each target music processing plugin is finally combined and laid out based on the visual template to generate the visual music information matching the target intention, and the visual music information is displayed on the interactive interface, thereby completing the music processing process.

Optionally, after step S205, it further includes:

Step S206: loading and displaying at least one interactive control for the visual music information, where the at least one interactive control is in one-to-one correspondence with the media resources constituting the visual music information, and the at least one interactive control is configured to control a display state of a corresponding media resource.

Exemplarily, the visual music information may be displayed in the interactive interface of the target application in the form of an interactive card. After the visual music information is generated, for the visual music information, a corresponding interactive control may be further configured in the interactive card corresponding to the visual music information, such as a play control for a music resource and a video resource in the visual music information, and for another example, a scaling control, a page turning control, etc. for an image resource in the visual music information. After that, based on the interactive control loaded above, the display state of the media resource may be controlled, such as play control and pause control for the music resource, scaling control and page turning control for the picture resource, etc. The loading of the above interactive control may be implemented by an interactive functional unit in the target application, and the interactive functional unit may obtain different interactive controls locally or externally and load them into the interactive interface of the target application.

In this embodiment, the implementations of step S201 and step S205 are the same as the implementations of step S101 and step S103 in one or more embodiments shown in FIG. 2 of the present disclosure, which will not be repeated here.

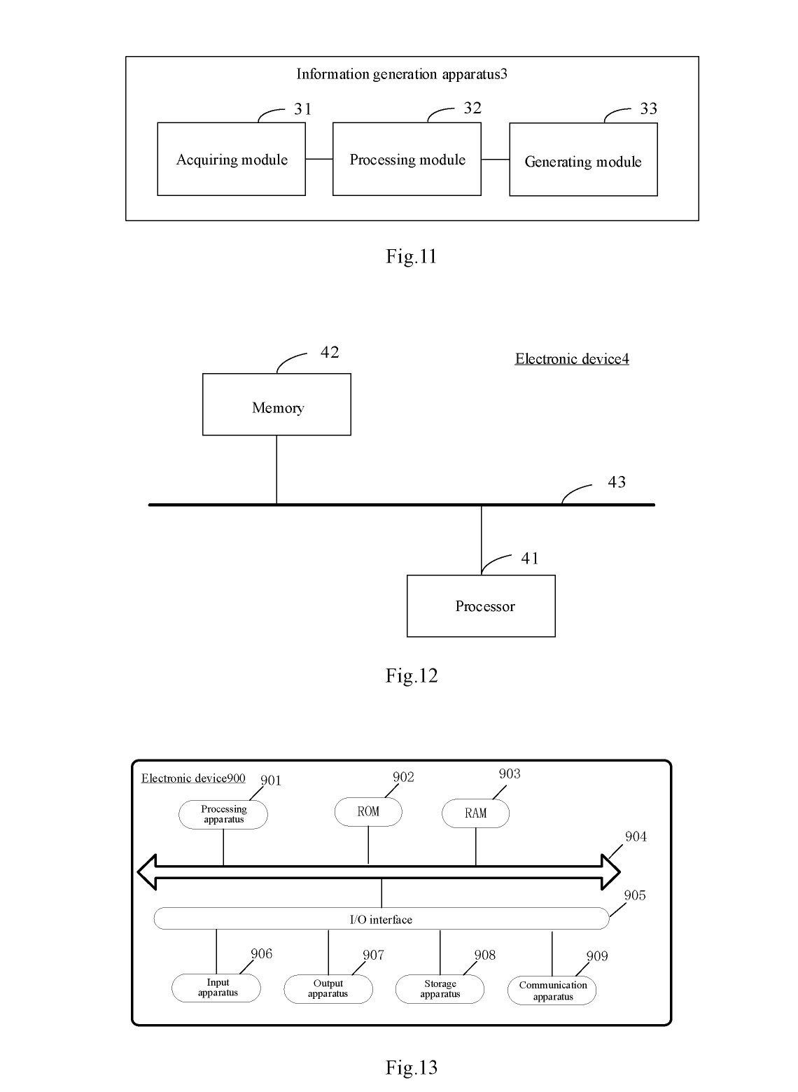

Corresponding to the information generation method of the above embodiments, FIG. 11 is a structural block diagram of an information generation apparatus provided by at least an embodiment of the present disclosure. The method introduced in the above embodiments may be executed by the information generation apparatus, which may be implemented by software and/or hardware, and the apparatus may be integrated in an electronic device with certain data processing functions. The electronic device may include, but is not limited to, a mobile terminal with big data processing capability, and a fixed terminal with big data processing capability, such as a desktop computer and a supercomputer.

For ease of description, only parts related to one or more embodiments of the present disclosure are shown. Referring to FIG. 11, the information generation apparatus 3 includes:

an acquiring module 31, configured to acquire multimodal input data, where the multimodal input data includes at least two types of media data, and the multimodal input data is configured to represent a target intention based on the at least two types of media data;

a processing module 32, configured to process the multimodal input data through a music processing agent, and invoke at least one music processing plugin according to a processing result to obtain a media resource corresponding to each of the at least one music processing plugin; and

a generating module 33, configured to combine media resources corresponding to the at least one music processing plugin to generate visual music information matching the target intention.

According to one or more embodiments of the present disclosure, the processing module 32 is further configured to: perform intention recognition on the multimodal input data through the music processing agent to obtain a target intention category corresponding to the target intention; and determine a corresponding target music processing plugin according to the target intention category, and invoke the target music processing plugin to obtain a corresponding media resource.

According to one or more embodiments of the present disclosure, the processing module 32 is further configured to: based on the target intention category, perform parameter extraction on the multimodal input data through the music processing agent to obtain a feature parameter corresponding to the target intention category; and convert the feature parameter into a control parameter matching the target music processing plugin. The processing module 32, when invoking the target music processing plugin to obtain a corresponding media resource, is further configured to: invoke the target music processing plugin based on the control parameter to obtain the corresponding media resource.

According to one or more embodiments of the present disclosure, the processing module 32, when invoking the target music processing plugin to obtain a corresponding media resource, is further configured to: invoke the target music processing plugin to acquire a corresponding music processing workflow; sequentially process the control parameter of the target music processing plugin based on the music processing workflow to generate a plugin output resource; and perform format conversion on the plugin output resource to generate a media resource having a target format, where the target format corresponds to the target intention.

According to one or more embodiments of the present disclosure, the processing module 32, when determining a corresponding target music processing plugin according to the target intention category, is further configured to: acquire a corresponding visual template according to the target intention category, where the visual template is at least configured to represent at least one piece of target media resource constituting the visual music information; and acquire, based on the visual template, a target music processing plugin configured to generate each of the at least one piece of target media resource.

According to one or more embodiments of the present disclosure, the target intention category includes at least one of the following: intelligent music matching, music search, music identification, and music introduction.

According to one or more embodiments of the present disclosure, the generating module 33 is further configured to acquire a visual template matching the target intention, where the visual template is configured to determine a layout style of the visual music information; and combine the media resources generated by the at least one music processing plugin based on the visual template to generate the visual music information matching the target intention.

According to one or more embodiments of the present disclosure, the visual template includes a first visual template, and the generating module 33, when acquiring the visual template matching the target intention, is further configured to perform intention recognition on the multimodal input data through the music processing agent to obtain an intention feature for describing the target intention; and process the intention feature based on a generation model to generate the first visual template, where the first visual template is configured to represent a display position of a target media resource corresponding to the target intention.

According to one or more embodiments of the present disclosure, the visual template includes a second visual template, and the generating module 33, when acquiring the visual template matching the target intention, is further configured to perform intention recognition on the multimodal input data through the music processing agent to obtain a target intention category corresponding to the target intention and the number of media resource bits; and acquire the corresponding second visual template according to the target intention category and the number of media resource bits, where the second visual template is configured to represent a user interface layout composed of a target number of the media resource bits.

According to one or more embodiments of the present disclosure, the generating module 33 is further configured to load and display at least one interactive control for the visual music information, where the at least one interactive control is in one-to-one correspondence with the media resources constituting the visual music information, and the at least one interactive control is configured to control a display state of a corresponding media resource.

The acquiring module 31, the processing module 32 and the generating module 33 are connected in sequence. The information generation apparatus 3 provided by this embodiment may execute the technical solutions of the above method embodiments, and the implementation principles and technical effects thereof are similar, and details are not repeated here in this embodiment.

FIG. 12 is a schematic structural diagram of an electronic device provided by at least an embodiment of the present disclosure. As shown in FIG. 12, the electronic device 4 includes:

a processor 41, and a memory 42 communicatively connected to the processor 41;

the memory 42 is stored with a computer-executable instruction; and

the computer instruction, when executed by the processor 41, causes the processor 41 to perform the information generation method in the embodiments shown in FIGS. 2 to 10.

Optionally, the processor 41 and the memory 42 are connected through a bus 43.

The relevant descriptions may be understood by referring to the relevant descriptions and effects corresponding to the steps in the embodiments corresponding to FIGS. 2 to 10, and details are not repeated here.

One or more embodiments of the present disclosure provides a non-transitory computer-readable storage medium, where a computer-executable instruction is stored in the computer-readable storage medium, and the computer instruction, when executed by at least a processor, cause the processor to implement the information generation method provided by any one of one or more embodiments corresponding to FIGS. 2 to 10 of the present disclosure.

One or more embodiments of the present disclosure provides a computer program product, including a computer program, and the computer program, when executed by a processor, causes the processor to perform the information generation method provided by any one of one or more embodiments corresponding to FIGS. 2 to 10 of the present disclosure is implemented.

In order to implement the above embodiments, one or more embodiments of the present disclosure further provides an electronic device.

Referring to FIG. 13, it shows a schematic structural diagram of an electronic device 900 suitable for implementing one or more embodiments of the present disclosure, and the electronic device 900 may be a terminal device or a server. The terminal device may include, but is not limited to, mobile terminals such as a mobile phone, a notebook computer, a digital broadcast receiver, a personal digital assistant (abbreviated as PDA), a tablet computer, a portable media player (abbreviated as PMP), a vehicle-mounted terminal (such as a vehicle navigation terminal), etc., and fixed terminals such as a digital TV, a desktop computer, etc. The electronic device shown in FIG. 13 is only an example, and should not impose any limitation on the function and scope of use of one or more embodiments of the present disclosure.

As shown in FIG. 13, the electronic device 900 may include a processing apparatus (such as a central processing unit, a graphics processor, etc.) 901, which may perform various appropriate actions and processes according to a program stored in a read-only memory (abbreviated as ROM) 902 or a program loaded from a storage apparatus 908 into a random access memory (abbreviated as RAM) 903. In the RAM 903, various programs and data necessary for the operation of the electronic device 900 are also stored. The processing apparatus 901, the ROM 902 and the RAM 903 are connected to each other through a bus 904. An input/output (I/O) interface 905 is also connected to the bus 904.

Usually, the following apparatus may be connected to the I/O interface 905: an input apparatus 906 including, for example, a touch screen, a touchpad, a keyboard, a mouse, a camera, a microphone, an accelerometer, a gyroscope, etc.; an output apparatus 907 including, for example, a liquid crystal display (abbreviated as LCD), a speaker, a vibrator, etc.; a storage apparatus 908 including, for example, a tape, a hard disk, etc.; and a communication apparatus 909. The communication apparatus 909 may allow the electronic device 900 to perform wireless or wired communication with other devices to exchange data. Although FIG. 13 shows the electronic device 900 with various apparatuses, it should be understood that it is not required to implement or have all the apparatuses shown. Alternatively, more or fewer apparatuses may be implemented or provided.

In particular, according to one or more embodiments of the present disclosure, the process described above with reference to the flowchart may be implemented as a computer software program. For example, one or more embodiments of the present disclosure include a computer program product, which includes a computer program carried on a computer-readable medium, where the computer program contains program codes for executing the method shown in the flowchart. In such an embodiment, the computer program may be downloaded and installed from the network through the communication apparatus 909, or installed from the storage apparatus 908, or installed from the ROM 902. When the computer program is executed by the processing apparatus 901, the above-mentioned functions defined in the method of one or more embodiments of the present disclosure are executed.

It should be noted that the above-mentioned computer-readable medium in one or more embodiments of the present disclosure may be a computer-readable signal medium, a computer-readable storage medium, or any combination of the two. The computer-readable storage medium may be, for example, but not limited to, an electrical, magnetic, optical, electromagnetic, infrared, or semiconductor system, apparatus or device, or any combination of the above. More specific examples of the computer-readable storage medium may include, but are not limited to: an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In one or more embodiments of the present disclosure, a computer-readable storage medium may be any tangible medium that contains or stores a program, which may be used by or in combination with an instruction execution system, apparatus, or device. In one or more embodiments of the present disclosure, a computer-readable signal medium may include a data signal propagated in a baseband or as a part of a carrier wave, and computer-readable program codes are carried therein. This propagated data signal may take many forms, including but not limited to electromagnetic signals, optical signals, or any suitable combination of the above. The computer-readable signal medium may also be any computer-readable medium other than the computer-readable storage medium, and the computer-readable signal medium may send, propagate, or transmit the program used by or in combination with the instruction execution system, apparatus, or device. The program codes contained on the computer-readable medium may be transmitted by any suitable medium, including but not limited to: wires, optical cables, RF (radio frequency), etc., or any suitable combination of the above.

The above-mentioned computer-readable medium may be included in the above-mentioned electronic device; or it may exist alone without being assembled into the electronic device.

The above computer-readable medium carries one or more programs, which, when executed by the electronic device, cause the electronic device to execute the method shown in the above embodiments.

The computer program codes for performing the operations of one or more embodiments of the present disclosure may be written in one or more programming languages or a combination thereof, where the above programming languages include object-oriented programming languages such as Java, Smalltalk, C++, and also include conventional procedural programming languages such as "C" language or similar programming languages. The program codes may be executed entirely on a user's computer, partly executed on a user's computer, executed as an independent software package, partly executed on a user's computer and partly executed on a remote computer, or entirely executed on a remote computer or a server. In the case of involving a remote computer, the remote computer may be connected to a user's computer through any kind of network, including a local area network (abbreviated as LAN) or a wide area network (abbreviated as WAN), or it may be connected to an external computer (for example, connected by using Internet provided by an Internet service provider).

The flowcharts and block diagrams in the drawings illustrate the possibly implemented architectures, functions, and operations of the system, method and computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and the combination of the blocks in the block diagram and/or the flowchart may be implemented by a dedicated hardware-based system that executes specified functions or operations, or may be implemented by a combination of dedicated hardware and computer instructions.

The involved units or modules described in one or more embodiments of the present disclosure may be implemented by means of software, and may also be implemented by means of hardware. Among them, the name of the unit or module does not constitute a limitation on the unit itself under certain circumstances.

The functions described above herein may be performed at least in part by one or more hardware logic components. For example, without limitation, exemplary types of hardware logic components that may be used include: field programmable gate array (FPGA), application specific integrated circuit (ASIC), application specific standard product (ASSP), system on chip (SOC), complex programmable logic device (CPLD), etc.

In the context of the present disclosure, a machine-readable medium may be a tangible medium that may contain or store a program for use by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium would include an electrical connection based on one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

### In a first aspect, according to one or more embodiments of the present disclosure, an information generation method is provided, including:

acquiring multimodal input data, where the multimodal input data includes at least two types of media data, and the multimodal input data is configured to represent a target intention (e.g., first intention) based on the at least two types of media data; processing the multimodal input data through a music processing agent, and invoking at least one music processing plugin according to a processing result to obtain a media resource corresponding to each of the at least one music processing plugin; and combining media resources corresponding to the at least one music processing plugin to generate visual music information matching the target intention.

According to one or more embodiments of the present disclosure, the processing the multimodal input data through a music processing agent, and invoking at least one music processing plugin according to a processing result to obtain a media resource corresponding to each of the at least one music processing plugin includes: performing intention recognition on the multimodal input data through the music processing agent to obtain a target intention category (e.g., first intention category) corresponding to the target intention; and determining a corresponding target music processing plugin (e.g, first music processing plugin)according to the target intention category, and invoking the target music processing plugin to obtain a corresponding media resource.

According to one or more embodiments of the present disclosure, the method further includes: based on the target intention category, performing parameter extraction on the multimodal input data through the music processing agent to obtain a feature parameter corresponding to the target intention category; and converting the feature parameter into a control parameter matching the target music processing plugin. The invoking the target music processing plugin to obtain the corresponding media resource includes: invoking the target music processing plugin based on the control parameter to obtain the corresponding media resource.

According to one or more embodiments of the present disclosure, the invoking the target music processing plugin to obtain the corresponding media resource includes: invoking the target music processing plugin to acquire a corresponding music processing workflow; sequentially processing the control parameter of the target music processing plugin based on the music processing workflow to generate a plugin output resource; and performing format conversion on the plugin output resource to generate the media resource having a target format (e.g., first format), where the target format corresponds to the target intention.

According to one or more embodiments of the present disclosure, the determining a corresponding target music processing plugin according to the target intention category includes: acquiring a corresponding visual template according to the target intention category, where the visual template is at least configured to represent at least one piece of target media resource constituting the visual music information; and acquiring, based on the visual template, a target music processing plugin configured to generate each of the at least one piece of target media resource (e.g., first media resource).

According to one or more embodiments of the present disclosure, the target intention category includes at least one of the following: intelligent music matching, music search, music identification, and music introduction.

According to one or more embodiments of the present disclosure, the combining the media resources corresponding to the at least one music processing plugin to generate visual music information matching the target intention includes: acquiring a visual template matching the target intention, where the visual template is configured to determine a layout style of the visual music information; and combining the media resources generated by the at least one music processing plugin based on the visual template to generate the visual music information matching the target intention.

According to one or more embodiments of the present disclosure, the visual template includes a first visual template, and the acquiring a visual template matching the target intention includes: performing intention recognition on the multimodal input data through a music processing agent to obtain an intention feature for describing the target intention; and processing the intention feature based on a generation model to generate the first visual template, where the first visual template is configured to represent a display position of a target media resource corresponding to the target intention.

According to one or more embodiments of the present disclosure, the visual template includes a second visual template, and the acquiring a visual template matching the target intention includes: performing intention recognition on the multimodal input data through the music processing agent to obtain a target intention category corresponding to the target intention and the number of media resource bits; and acquiring a corresponding second visual template according to the target intention category and the number of media resource bits, where the second visual template is configured to represent a user interface layout comprising a target number (e.g., first number) of the media resource bits.

According to one or more embodiments of the present disclosure, the method further includes: for the visual music information, loading and displaying at least one interactive control, where the at least one interactive control are in one-to-one correspondence with the media resources constituting the visual music information, and the at least one interactive control is configured to control a display state of a corresponding media resource.

### In a second aspect, according to one or more embodiments of the present disclosure, an information generation apparatus is provided, including:

an acquiring module, configured to acquire multimodal input data, where the multimodal input data includes at least two types of media data, and the multimodal input data is configured to represent a target intention based on the at least two types of media data;

a processing module, configured to process the multimodal input data through a music processing agent, and invoke at least one music processing plugin according to a processing result to obtain a media resource corresponding to each of the at least one music processing plugin; and

a generating module, configured to combine media resources corresponding to the at least one music processing plugin to generate visual music information matching the target intention.

According to one or more embodiments of the present disclosure, the processing module is further configured to: perform intention recognition on the multimodal input data through the music processing agent to obtain a target intention category corresponding to the target intention; and determine a corresponding target music processing plugin according to the target intention category, and invoke the target music processing plugin to obtain the corresponding media resource.

According to one or more embodiments of the present disclosure, the processing module is further configured to: based on the target intention category, perform parameter extraction on the multimodal input data through the music processing agent to obtain a feature parameter corresponding to the target intention category; and convert the feature parameter into a control parameter matching the target music processing plugin. The processing module 32, when invoking the target music processing plugin to obtain a corresponding media resource, is further configured to: invoke the target music processing plugin based on the control parameter to obtain the corresponding media resource.

According to one or more embodiments of the present disclosure, the processing module, when invoking the target music processing plugin to obtain a corresponding media resource, is further configured to: invoke the target music processing plugin to acquire a corresponding music processing workflow; sequentially process the control parameter of the target music processing plugin based on the music processing workflow to generate a plugin output resource; and perform format conversion on the plugin output resource to generate a media resource having a target format, where the target format corresponds to the target intention.

According to one or more embodiments of the present disclosure, the processing module, when determining the corresponding target music processing plugin according to the target intention category, is further configured to: acquire a corresponding visual template according to the target intention category, where the visual template is at least configured to represent at least one piece of target media resource constituting the visual music information; and acquire, based on the visual template, a target music processing plugin configured to generate each of the at least one piece of target media resource.

According to one or more embodiments of the present disclosure, the target intention category includes at least one of the following: intelligent music matching, music search, music identification, and music introduction.

According to one or more embodiments of the present disclosure, the generating module is further configured to: acquire a visual template matching the target intention, where the visual template is configured to determine a layout style of the visual music information; and combine the media resources generated by the at least one music processing plugin based on the visual template to generate the visual music information matching the target intention.

According to one or more embodiments of the present disclosure, the visual template includes a first visual template, and the generating module, when acquiring the visual template matching the target intention, is further configured to perform intention recognition on the multimodal input data through the music processing agent to obtain an intention feature for describing the target intention; and process the intention feature based on a generation model to generate the first visual template, where the first visual template is configured to represent a display position of a target media resource corresponding to the target intention.

According to one or more embodiments of the present disclosure, the visual template includes a second visual template, and the generating module, when acquiring the visual template matching the target intention, is further configured to perform intention recognition on the multimodal input data through the music processing agent to obtain a target intention category corresponding to the target intention and the number of media resource bits; and acquire the corresponding second visual template according to the target intention category and the number of media resource bits, where the second visual template is configured to represent a user interface layout composed of a target number of the media resource bits.

According to one or more embodiments of the present disclosure, the generating module is further configured to: for the visual music information, load and display at least one interactive control, where the at least one interactive control is in one-to-one correspondence with the media resource constituting the visual music information, and the at least one interactive control is configured to control a display state of a corresponding media resource.

### In a third aspect, according to one or more embodiments of the present disclosure, an electronic device is provided, including: at least one processor and a memory;

wherein the memory is stored with a computer instruction executable by the processor, and the computer instruction, when executed by the processor, causes the processor to perform the information generation method according to the above first aspect and various possible designs of the first aspect.

In a fourth aspect, according to one or more embodiments of the present disclosure, a non-transitory computer-readable storage medium is provided, where the non-transitory computer-readable storage medium is stored with computer instructions, and the computer instructions, when executed by at least a processor, cause the processor to implement the information generation method according to the above first aspect and various possible designs of the first aspect.

In a fifth aspect, according to one or more embodiments of the present disclosure, a computer program product is provided, including a computer program, and the computer program, when executed by a processor, causes the processor to perform the information generation method according to the above first aspect and various possible designs of the first aspect is implemented.

The above description is only preferred embodiments of the present disclosure and an explanation of the applied technical principles. Those skilled in the art should understand that the disclosure scope involved in the present disclosure is not limited to the technical solutions formed by the specific combination of the above technical features, and should also cover other technical solutions formed by any combination of the above technical features or their equivalent features without departing from the above disclosure concept. For example, a technical solution formed by replacing the above features with technical features with similar functions disclosed in the present disclosure (but not limited to).

Furthermore, although the operations are depicted in a particular order, this should not be understood as requiring the operations to be performed in the particular order shown or in a sequential order. Under certain circumstances, multitasking and parallel processing may be advantageous. Similarly, although several specific implementation details are included in the above discussion, these should not be construed as limiting the scope of the present disclosure. Certain features described in the context of separate embodiments may also be implemented in combination in a single embodiment. On the other hand, various features described in the context of a single embodiment may also be implemented in multiple embodiments individually or in any suitable sub-combination.

Although the subject matter has been described in terms specific to structural features and/or logical actions of the method, it should be understood that the subject matter defined in the appended claims is not necessarily limited to the specific features or actions described above. On the contrary, the specific features and actions described above are only exemplary forms for implementing the claims.

1. An information generation method, comprising:
acquiring multimodal input data, wherein the multimodal input data comprises at least two types of media data, and the multimodal input data is configured to represent a first intention based on the at least two types of media data;
processing the multimodal input data through a music processing agent, and invoking at least one music processing plugin according to a processing result to obtain a respective one of media resources corresponding to each of the at least one music processing plugin; and
combining the media resources, each of which corresponds to a respective one of the at least one music processing plugin, to generate visual music information matching the first intention.

2. The method of claim 1, wherein the processing the multimodal input data through a music processing agent, and invoking at least one music processing plugin according to a processing result to obtain a respective one of media resources corresponding to each of the at least one music processing plugin comprises:
performing intention recognition on the multimodal input data through the music processing agent to obtain a first intention category corresponding to the first intention; and
determining a first music processing plugin according to the first intention category, and
invoking the first music processing plugin to obtain a corresponding media resource.

3. The method of claim 2, further comprising:
based on the first intention category, performing parameter extraction on the multimodal input data through the music processing agent to obtain a feature parameter corresponding to the first intention category; and
converting the feature parameter into a control parameter matching the first music processing plugin; and
the invoking the first music processing plugin to obtain a corresponding media resource comprises:
invoking the first music processing plugin based on the control parameter to obtain the corresponding media resource.

4. The method of claim 3, wherein the invoking the first music processing plugin to obtain a corresponding media resource comprises:
invoking the first music processing plugin to acquire a corresponding music processing workflow;
sequentially processing the control parameter of the first music processing plugin based on the music processing workflow to generate a plugin output resource; and
performing format conversion on the plugin output resource to generate the media resource having a first format, wherein the first format corresponds to the first intention.

5. The method of claim 2, wherein the determining a first music processing plugin according to the first intention category comprises:
acquiring a visual template according to the first intention category, wherein the visual template is at least configured to represent at least one piece of first media resource constituting the visual music information; and
acquiring, based on the visual template, a first music processing plugin configured for generating each of the at least one piece of first media resource.

6. The method of claim 2, wherein the first intention category comprises at least one selected from the group of:
intelligent music matching, music search, music identification, and music introduction.

7. The method of claim 1, wherein the combining the media resources, each of which corresponds to a respective one of the at least one music processing plugin, to generate visual music information matching the first intention comprises:
acquiring a visual template matching the first intention, wherein the visual template is configured to determine a layout style of the visual music information; and
combining the media resources generated by the at least one music processing plugin based on the visual template to generate the visual music information matching the first intention.

8. The method of claim 7, wherein the visual template comprises a first visual template, and the acquiring a visual template matching the first intention comprises:
performing intention recognition on the multimodal input data through a music processing agent to obtain an intention feature for describing the first intention; and
processing the intention feature based on a generation model to generate the first visual template, wherein the first visual template is configured to represent a display position of a first media resource corresponding to the first intention.

9. The method of claim 7, wherein the visual template comprises a second visual template, and the acquiring a visual template matching the first intention comprises:
performing intention recognition on the multimodal input data through a music processing agent to obtain a first intention category corresponding to the first intention and a number of media resource bits; and
acquiring a corresponding second visual template according to the first intention category and the number of media resource bits, wherein the second visual template is configured to represent a user interface layout comprising a first number of the media resource bits.

10. The method of claim 1, further comprising:
for the visual music information, loading and displaying at least one interactive control, wherein the at least one interactive control is in one-to-one correspondence with the media resources constituting the visual music information, and the at least one interactive control is configured to control a display state of a corresponding one of the media resources.

11. An electronic device, comprising: a processor and a memory;
at least one processor; and
a memory communicatively connected to the at least one processor,
wherein the memory is stored with a computer instruction executable by the processor, and the computer instruction, when executed by the processor, causes the processor to perform an information generation method, which comprises:
acquiring multimodal input data, wherein the multimodal input data comprises at least two types of media data, and the multimodal input data is configured to represent a first intention based on the at least two types of media data;
processing the multimodal input data through a music processing agent, and invoking at least one music processing plugin according to a processing result to obtain a respective one of media resources corresponding to each of the at least one music processing plugin; and
combining the media resources, each of which corresponds to a respective one of the at least one music processing plugin, to generate visual music information matching the first intention.

12. The electronic device of claim 11, wherein the processing the multimodal input data through a music processing agent, and invoking at least one music processing plugin according to a processing result to obtain a respective one of media resources corresponding to each of the at least one music processing plugin comprises:
performing intention recognition on the multimodal input data through the music processing agent to obtain a first intention category corresponding to the first intention;
determining a corresponding first music processing plugin according to the first intention category, and
invoking the first music processing plugin to obtain a corresponding media resource.

13. The electronic device of claim 12, the at least one processor is caused to further perform:
based on the first intention category, performing parameter extraction on the multimodal input data through the music processing agent to obtain a feature parameter corresponding to the first intention category; and
converting the feature parameter into a control parameter matching the first music processing plugin; and
the invoking the first music processing plugin to obtain a corresponding media resource comprises:
invoking the first music processing plugin based on the control parameter to obtain the corresponding media resource.

14. The electronic device of claim 13, wherein the invoking the first music processing plugin to obtain a corresponding media resource comprises:
invoking the first music processing plugin to acquire a corresponding music processing workflow;
sequentially processing the control parameter of the first music processing plugin based on the music processing workflow to generate a plugin output resource; and
performing format conversion on the plugin output resource to generate the media resource having a first format, wherein the first format corresponds to the first intention.

15. The electronic device of claim 12, wherein the determining a first music processing plugin according to the first intention category comprises:
acquiring a visual template according to the first intention category, wherein the visual template is at least configured to represent at least one piece of first media resource constituting the visual music information; and
acquiring, based on the visual template, a first music processing plugin configured for generating each of the at least one piece of first media resource.

16. The electronic device of claim 12, wherein the first intention category comprises at least one selected from the group of:
intelligent music matching, music search, music identification, and music introduction.

17. The electronic device of claim 11, wherein the combining the media resources, each of which corresponds to a respective one of the at least one music processing plugin to generate visual music information matching the first intention comprises:
acquiring a visual template matching the first intention, wherein the visual template is configured to determine a layout style of the visual music information; and
combining the media resources generated by the at least one music processing plugin based on the visual template to generate the visual music information matching the first intention.

18. The electronic device of claim 17, wherein the visual template comprises a first visual template, and the acquiring a visual template matching the first intention comprises:
performing intention recognition on the multimodal input data through a music processing agent to obtain an intention feature for describing the first intention; and
processing the intention feature based on a generation model to generate the first visual template, wherein the first visual template is configured to represent a display position of a first media resource corresponding to the first intention.

19. The electronic device of claim 17, wherein the visual template comprises a second visual template, and the acquiring a visual template matching the first intention comprises:
performing intention recognition on the multimodal input data through a music processing agent to obtain a first intention category corresponding to the first intention and a number of media resource bits; and
acquiring a corresponding second visual template according to the first intention category and the number of media resource bits, wherein the second visual template is configured to represent a user interface layout comprising a first number of the media resource bits.

20. A non-transitory computer-readable storage medium, wherein the computer-readable storage medium is stored with computer instructions, and the computer instructions, when executed by at least a processor, cause the processor to implement an information generation method, which comprises:
acquiring multimodal input data, wherein the multimodal input data comprises at least two types of media data, and the multimodal input data is configured to represent a first intention based on the at least two types of media data;
processing the multimodal input data through a music processing agent, and invoking at least one music processing plugin according to a processing result to obtain a respective one of media resources corresponding to each of the at least one music processing plugin; and
combining the media resources, each of which corresponds to a respective one of the at least one music processing plugin, to generate visual music information matching the first intention.
